(19) United States
(12) Patent Application Publication
(10) Pub. No.: US 2008/0292959 A1
(43) Pub. Date: Nov. 27, 2008

(54) Positive Electrode and Non-Aqueous Electrolyte Secondary Battery Using the Same

(76) Inventors: Takao Inoue, Aichi (JP); Masahisa Fujimoto, Osaka (JP)

Correspondence Address: KRATZ, QUINTOS & HANSON, LLP, 1420 K Street, N.W., Suite 400, WASHINGTON, DC, 20005, US

(21) Appl. No.: 11/883,808

(22) PCT Filed: Jan. 20, 2006
(86) PCT No.: PCT/JP2006/300881

§ 371 Date: May 22, 2008

(30) Foreign Application Priority Data
Feb. 7, 2005 (JP) 2005-030893

(51) Int. Cl. H01M 6/04

(52) U.S. Cl. 429/188

(57) ABSTRACT

An object of the invention is to provide a positive electrode of an inexpensive material capable of sufficiently storing and releasing ions, and another object is to provide an inexpensive non-aqueous electrolyte secondary battery that allows reversible charge and discharge to be carried out. The positive electrode according to the invention includes an oxide containing potassium and manganese, and the non-aqueous electrolyte secondary battery according to the invention includes a positive electrode, a negative electrode, and a non-aqueous electrolyte containing potassium ions. The positive electrode includes an oxide containing potassium and manganese.

### TECHNICAL FIELD

The present invention relates to a positive electrode and a non-aqueous electrolyte secondary battery including the positive electrode, a negative electrode, and a non-aqueous electrolyte.

### BACKGROUND ART

Today, non-aqueous electrolyte secondary batteries are in wide use as secondary batteries with high energy density, in which lithium ions for example are transferred between a positive electrode and a negative electrode to carry out charge and discharge.

In such a non-aqueous electrolyte secondary battery in general, a composite oxide of a lithium transition metal having a layered structure of lithium nickel oxide (LiNiO₂), lithium cobalt oxide (LiCoO₂) or the like is used as the positive electrode, and a carbon material capable of storing and releasing lithium, a lithium metal, a lithium alloy, or the like is used as the negative electrode (see, for example, Patent Document 1).

Using the above-mentioned non-aqueous electrolyte secondary battery, a discharge capacity from 150 mAh/g to 180 mAh/g, a potential of about 4 V and a theoretical capacity of about 260 mAh/g can be obtained.

The non-aqueous electrolyte produced by dissolving an electrolyte salt such as lithium tetrafluoroborate (LiBF₄) or lithium hexafluorophosphate (LiPF₆) for example in an organic solvent such as ethylene carbonate or diethyl carbonate is used.

[Patent Document 1] JP 2003-151549 A

### DISCLOSURE OF THE INVENTION

### Problems to be Solved by the Invention

In such a conventional non-aqueous electrolyte secondary battery using lithium ions, however, an oxide of cobalt (Co) or nickel (Ni) is mainly used as the positive electrode, and these materials are limited as resources.

When all the lithium ions are released from the lithium nickel oxide or lithium cobalt oxide in the non-aqueous electrolyte secondary battery, the crystal structure of the lithium nickel oxide or lithium cobalt oxide is destroyed. Consequently, oxygen is released from the lithium nickel oxide or lithium cobalt oxide, which gives rise to safety concerns. Therefore, the discharge capacity cannot be increased from the described level.

In some cases, manganese (Mn) as a naturally abundant resource is used instead of nickel or cobalt, but the capacity of the resulting non-aqueous electrolyte secondary battery is halved.

The use of manganese makes it difficult to produce lithium manganese oxide (LiMnO₂) having a layered structure employed to improve the mobility of lithium ions. Therefore, lithium manganese oxide (LiMn₂O₄) having a spinel structure is generally used. In the case of LiMn₂O₄, the state of MnO₂ is maintained after all the lithium ions are released. Since manganese is stable in a quadrivalent state, oxygen is not released and the safety is well secured.

Using LiMn₂O₄, however, while a potential of 4 V can be obtained, only a discharge capacity from 100 mAh/g to 120 mAh/g can be obtained.

There have been attempts to produce LiMnO₂ with a layered structure, but the potential is reduced to about 3V and repetition of discharge/charge cycles changes the LiMnO₂ into LiMn₂O₄ in a spinel structure. It is believed that LiMnO₂ in a layered structure is not chemically stable because the radius of the lithium ions is small.

It is an object of the invention to provide a positive electrode of an inexpensive material that can sufficiently store and release ions.

Another object of the invention is to provide an inexpensive non-aqueous electrolyte secondary battery that allows reversible charge and discharge to be carried out.

### Means for Solving the Problems

A positive electrode according to one aspect of the invention includes an oxide containing potassium and manganese.

In the positive electrode according to the invention, the positive electrode includes an oxide containing potassium and manganese, and potassium ions are sufficiently stored in and released from the positive electrode. Furthermore, the use of potassium that is available in abundance as a resource can reduce the cost.

The oxide may include K×MnO_{2+y}, x may be more than 0 and at most 1, and y may be more than −0.1 and less than 0.1. In this way, potassium ions are efficiently stored in and released from the positive electrode.

A non-aqueous electrolyte secondary battery according to another aspect of the invention includes a positive electrode, a negative electrode, and a non-aqueous electrolyte containing potassium ions, and the positive electrode includes an oxide containing potassium and manganese.

In the non-aqueous electrolyte secondary battery according to the invention, the use of the positive electrode including an oxide containing potassium and manganese allows reversible charge and discharge to be carried out and the cost to be reduced.

The negative electrode may include a material capable of storing and releasing potassium. In this way, reversible charge and discharge can surely be carried out.

The negative electrode may contain carbon. In this way, a high energy density can be obtained.

The non-aqueous electrolyte may include potassium hexafluorophosphate. In this way, improved safety can be obtained.

The non-aqueous electrolyte may include one or more selected from the group consisting of a cyclic carbonate, a chain carbonate, esters, cyclic ethers, chain ethers, nitrites, and amides. In this way, the cost can be reduced and improved safety can be secured.

### EFFECTS OF THE INVENTION

The positive electrode according to the invention allows potassium ions to be sufficiently stored in and released from the positive electrode. The use of potassium that is available in abundance as a resource can reduce the cost.

In the non-aqueous electrolyte secondary battery according to invention, the use of the positive electrode including an oxide containing potassium and manganese allows reversible charge and discharge to be carried out, and the use of potassium that is available in abundance as a resource can reduce the cost.

### BRIEF DESCRIPTION OF THE DRAWINGS

FIG. 1 is a perspective view of a non-aqueous electrolyte secondary battery according to an embodiment.

FIG. 2 is a schematic sectional view of the non-aqueous electrolyte secondary battery shown in FIG. 1.

FIG. 3 is a graph showing the charge/discharge characteristic of the non-aqueous electrolyte secondary battery.

### BEST MODE FOR CARRYING OUT THE INVENTION

Now, a positive electrode according to an embodiment and a non-aqueous electrolyte secondary battery using the same will be described.

The non-aqueous electrolyte secondary battery according to the embodiment includes a positive electrode, a negative electrode, and a non-aqueous electrolyte.

Note that the materials, and the thickness, the concentrations and the like of the materials are not limited to those in the following description and may be set as required.

<Manufacture of Positive Electrode>

A material (hereinafter referred to as “positive electrode material”) containing 85 parts by weight of potassium manganese oxide (K×MnO_{2+y}) (for example 0<x≦1, −0.1<y<0.1) powder as a positive electrode active material, 10 parts by weight of Ketjenblack, carbon black powder serving as a conductive agent, and 5 parts by weight of polyvinylidene fluoride as a binder is prepared.

According to the embodiment, as an example of the potassium manganese oxide, potassium manganese oxide defined by JCPDS (Joint Committee on Powder Diffraction Standards) as card No. 160205 is used. The JCPDS has a database of X-ray diffraction data of about 6000 kinds of inorganic and organic compounds. The crystal system of the potassium manganese oxide by this card number is disclosed as “unknown” by the JCPDS.

Note that examples of potassium manganese oxide that can be used in place of card No. 160205 potassium manganese oxide described above include card No. 311052 potassium manganese oxide, card No. 311048 potassium manganese oxide of a monoclinic system (b-axis) (S. G. C), and card Nos. 441025 and 752171 potassium manganese oxide of a monoclinic system (b-axis) (S. G. P21/m).

The positive electrode material is for example mixed to a 10% N-methylpyrrolidone solution by weight to the positive electrode material, and slurry as a positive electrode mixture is produced.

Then, the slurry is for example applied by a doctor blade method on a 3-by-3 cm region of an aluminum foil as thick as 18 μm for example as a positive electrode collector, then dried and formed into a positive electrode active material layer.

Then, a positive electrode tab is attached on a region of the aluminum foil where the positive electrode active material layer is not formed to form a positive electrode.

Note that instead of the polyvinylidene fluoride, the binder in the positive electrode material may be at least one selected from polytetrafluoroethylene, polyethylene oxide, polyvinyl acetate, polymethacrylate, polyacrylate, polyacrylonitrile, polyvinyl alcohol, styrene-butadiene rubber, carboxymethylcellulose, and the like.

If the amount of the binder is excessive, the ratio of the positive electrode active material contained in the positive electrode material is reduced, and therefore a high energy density cannot be obtained. Therefore, the amount of the binder is from 0% to 30% by weight relative to the entire positive electrode material, preferably from 0% to 20% by weight, more preferably from 0% to 10% by weight.

Instead of the Ketjenblack as the conductive agent contained in the positive electrode material, other carbon materials such as acetylene black and graphite may be used. Note that if the content of the conductive agent is too small, the conductivity of the positive electrode material cannot be sufficiently improved, while if the amount of the agent is excessive, the ratio of the positive electrode active material contained in the positive electrode material is reduced, and a high energy density cannot be obtained. Therefore, the amount of the conductive agent is from 0% to 30% by weight relative to the entire positive electrode material, preferably from 0% to 20% by weight, more preferably from 0% to 10% by weight.

As the positive electrode collector, foamed aluminum, foamed nickel or the like may be used to improve the electronic conductivity.

<Manufacture of Negative Electrode>

A negative electrode active material of carbon for example and polyvinylidene fluoride (PVDF) as a binder are added so that the ratio of these materials is 95:5 and then mixed in order to produce slurry as a negative electrode mixture.

Then, for example, N-methyl-2-pyrrolidone is added to the negative electrode mixture, followed by mixing and kneading, so that the slurry is produced.

Then, the slurry is applied to both surfaces of a copper foil as thick as 20 μm for example that serves as a negative collector, so that a negative electrode active material layer is formed.

Then, the collector having the negative electrode active material layer formed thereon is cut into a 2.0-by-2.0 cm piece, and a negative electrode tab is attached to the piece, so that the negative electrode is produced.

<Manufacture of Non-aqueous Electrolyte>

A non-aqueous electrolyte produced by dissolving an electrolyte salt in a non-aqueous solvent may be used.

Examples of the non-aqueous solvent may include a cyclic carbonate, a chain carbonate, esters, cyclic ethers, chain ethers, nitrites, amides, and a combination thereof, which are typically used as a non-aqueous solvent for a battery.

Examples of the cyclic carbonate may include ethylene carbonate, propylene carbonate, butylene carbonate, and any of the above having its hydrogen group partly or entirely fluorinated such as trifluoropropylene carbonate and fluoroethyl carbonate.

Examples of the chain carbonate may include dimethyl carbonate, ethyl methyl carbonate, diethyl carbonate, methyl propyl carbonate, ethyl propyl carbonate, methyl isopropyl carbonate, and any of the above having its hydrogen group partly or entirely fluorinated.

Examples of the esters may include methyl acetate, ethyl acetate, propyl acetate, methyl propionate, ethyl propionate, and γ-butyrolactone. Examples of the cyclic ethers may include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and a crown ether.

Examples of the chain ethers may include 1,2-dimethoxyethane, diethyl ether, dipropyl ether, diisopropyl ether, dibutyl ether, dihexyl ether, ethyl vinyl ether, butyl vinyl ether, methylphenyl ether, ethylphenyl ether, butylphenyl ether, pentylphenyl ether, methoxytoluene, benzylethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

An example of the nitrites may include acetonitrile, and an example of the amides may include dimethylformamide.

Examples of the electrolyte salt may include substances excluding peroxides with high safety that are soluble to the non-aqueous solvent such as potassium hexafluorophosphate (KPF₆), potassium tetrafluoroborate (KBF₄), KCF₃SO₃, and KBeTi. Note that one of the above electrolyte salts may be used or two or more of the above may be combined for use.

According to the embodiment, the non-aqueous electrolyte is produced by adding potassium hexafluorophosphate as the electrolyte salt in a concentration of 0.7 mol/l to a non-aqueous solvent produced by mixing ethylene carbonate and diethyl carbonate in the ratio of 50:50 by volume.

<Manufacture of Non-aqueous Electrolyte Secondary Battery>

FIG. 1 is a perspective view of a non-aqueous electrolyte secondary battery according to the embodiment.

As shown in FIG. 1, the non-aqueous electrolyte secondary battery according to the embodiment includes a case body 40 and a negative electrode tab 47 and a positive electrode tab 48 are extended externally from the inside of the case body 40.

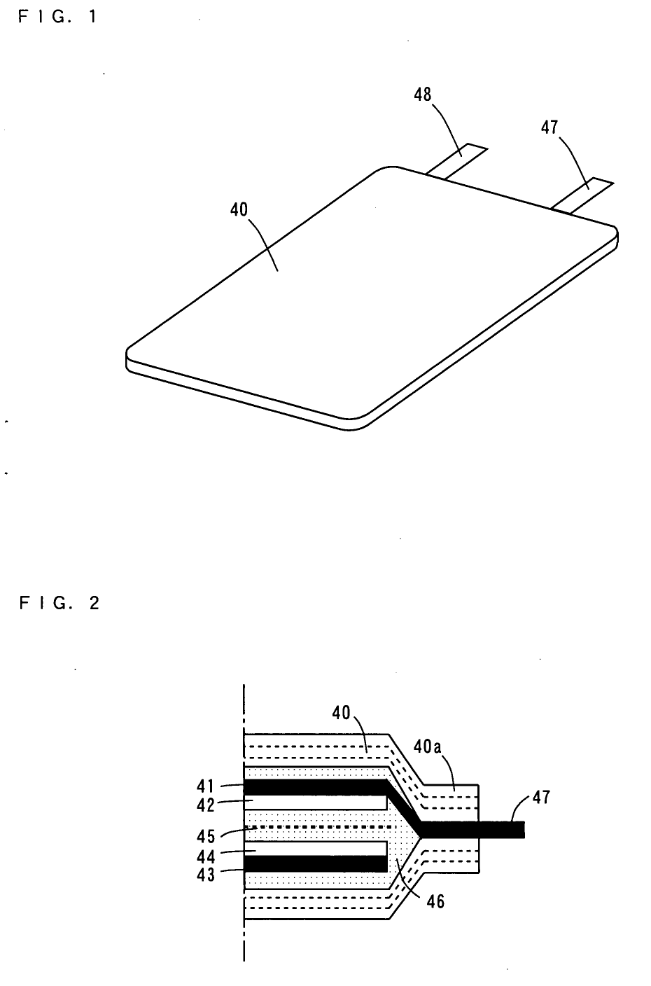

FIG. 2 is a schematic sectional view of the non-aqueous electrolyte secondary battery shown in FIG. 1. The case body 40 is made of a laminated film for example of aluminum.

As shown in FIG. 2, a negative electrode collector 41 and a positive electrode collector 43 are provided in the case body 40.

A negative electrode active material layer 42 including carbon is formed on the negative electrode collector 41, and a positive electrode active material layer 44 is formed on the positive electrode collector 43.

The negative electrode active material layer 42 formed on the negative electrode collector 41 and the positive electrode active material layer 44 formed on the positive electrode collector 43 are provided to be opposite to each other through a separator 45.

A non-aqueous electrolyte 46 is injected in the case body 40. At the end of the side of the case body 40 from which the negative electrode tab 47 and the positive electrode tab 48 are extended, a sealed opening 40a sealed by welding is formed.

The negative electrode tab 47 connected to the negative electrode collector 41 is externally extended through the sealed opening 40a. Although not shown in FIG. 2, the positive electrode tab 48 connected to the positive electrode collector 43 is also externally extended through the sealed opening 40a in the same manner as the negative electrode tab 47.

### EFFECTS OF EMBODIMENT

Using the positive electrode according to the embodiment, potassium ions are sufficiently stored in and released from the positive electrode. Furthermore, the use of potassium that is available in abundance as a resource can reduce the cost.

According to the embodiment, the use of the positive electrode for a non-aqueous electrolyte secondary battery allows reversible charge and discharge to be carried out and an inexpensive non-aqueous electrolyte secondary battery to be provided.

### Inventive Example

<Inventive Example and Evaluation Thereof>

As in the following paragraphs, the charge/discharge characteristic of a non-aqueous electrolyte secondary battery produced according to the embodiment was examined.

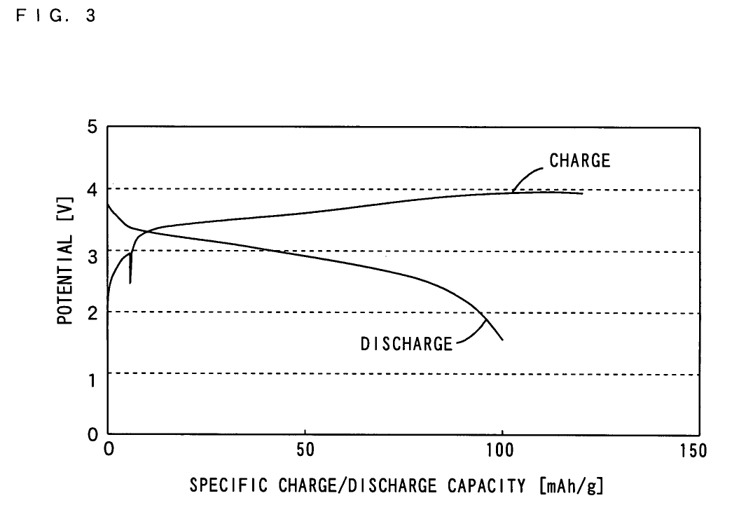

FIG. 3 is a graph showing the charge/discharge characteristic of the non-aqueous electrolyte secondary battery.

In the non-aqueous electrolyte secondary battery described above, charge was carried out until the specific charge capacity per gram of the negative electrode active material reached about 120 mAh/g with a constant current of 0.7 mA, and discharge was carried out until the discharge cutoff voltage was 1.5 V with a constant current of 0.7 mA.

It was found as a result that the specific discharge capacity per gram of the negative electrode active material was about 100 mAh/g and good charge and discharge was performed. More specifically, it was found that potassium ions were reversibly stored in and released from the positive electrode. In this way, the advantage of the new non-aqueous electrolyte secondary battery over the conventional non-aqueous electrolyte secondary battery using lithium ions was recognized.

### INDUSTRIAL APPLICABILITY

The non-aqueous electrolyte secondary battery according to the invention may be applied as various kinds of power supplies such as a portable power supply and an automotive power supply.

1: A non-aqueous electrolyte secondary battery comprising:
a positive electrode capable of storing and releasing potassium ions;
a negative electrode capable of storing and releasing potassium ions; and
a non-aqueous electrolyte including potassium ions,
said positive electrode including KₓMnO_{2+y}, wherein said x is more than 0 and at most 1 and said y is more than −0.1 and less than 0.1.

2: The non-aqueous electrolyte secondary battery according to claim 1, wherein said negative electrode includes carbon.

3: The non-aqueous electrolyte secondary battery according to claim 1, wherein said non-aqueous electrolyte includes potassium hexafluorophosphate.

4: The non-aqueous electrolyte secondary battery according to claim 1, wherein said non-aqueous electrolyte includes one or more selected from the group consisting of a cyclic carbonate, a chain carbonate, esters, cyclic ethers, chain ethers, nitriles, and amides.

5. (canceled)

6. (canceled)

7. (canceled)
